(19) United States
(12) Patent Application Publication
(10) Pub. No.: US 2011/0139065 A1
(43) Pub. Date: Jun. 16, 2011

(54) Cutting Device and Tape Printer Including Cutting Device

(75) Inventor: Shinsaku Kosuge, Nagano-ken (JP)

(73) Assignee: SEIKO EPSON CORPORATION, Tokyo (JP)

(21) Appl. No.: 12/959,843

(22) Filed: Dec. 3, 2010

(30) Foreign Application Priority Data
Dec. 11, 2009 (JP) 2009-281299

(51) Int. Cl. B05C 11/00; B05C 1/00; B26D 7/14

(52) U.S. Cl. 118/37; 83/175

(57) ABSTRACT

A cutting device which cuts a tape-shaped material in a width direction of the tape-shaped material, includes: a tape pressing mechanism which presses the tape-shaped material at the time of cutting the tape-shaped material, the tape pressing mechanism, a tape guiding unit which has a guiding surface for guiding the tape-shaped material and a receiving surface as a concaved portion with respect to the guiding surface, and a tape pressing unit which has a pressing surface for pressing the receiving surface of the tape guiding unit with the tape-shaped material sandwiched between the pressing surface and the receiving surface.

### CROSS REFERENCE TO RELATED APPLICATION

Japanese Patent Application No. 2009-281299 is hereby incorporated by reference in its entirety.

### BACKGROUND

1. Technical Field

The present invention relates to a cutting device and a tape printer including a cutting device.

2. Related Art

A tape printer which performs printing on a tape-shaped material as a lamination of a printing tape (adhesive-coated) and a released paper fed during printing, and cuts and separates a printed portion of the tape-shaped material to produce a label after printing is known. At the time of use of the label thus produced, the printing tape is separated from the released paper and affixed to a surface to which the printing tape is desired to be affixed. The method of cutting the tape-shaped material includes full-cut for cutting both the printing tape and the released paper by using a full-cut unit, and half-cut for cutting either the printing tape or the released paper by using a half-cut unit. The method of half-cut facilitates the separation of the printing tape from the released paper. A cutting device incorporated in the tape printer has only the full-cut unit, or both the full-cut unit and the half-cut unit, for example. The structure of this type of tape printer is disclosed in JP-A-2005-59183, for example.

The cutting device included in the tape printer has a tape pressing mechanism disposed at a position downstream from the full-cut unit and the half-cut unit for pressing and fixing the tape-shaped material at the time of full-cut or half-cut. FIGS. 5A and 5B are plan views illustrating a main part of a cutting device included in a related-art tape printer. More specifically, FIG. 5A is a plan view illustrating a condition of the tape printer performing printing, and FIG. 5B is a plan view illustrating a condition of the tape printer cutting a tape-shaped material.

As illustrated in FIGS. 5A and 5B, a tape pressing mechanism 600 included in a cutting device 10 of a related-art tape printer 5 contains a tape guiding unit 610 and a tape pressing unit 650. The tape guiding unit 610 has a guiding surface 611 for guiding a tape-shaped material 160 toward a tape ejection slot (not shown). The tape pressing unit 650 has a pressing surface 651 disposed opposed to the guiding surface 611 and pressing the tape-shaped material 160 against the guiding surface 611. A full-cut unit 200, for example, is disposed at a position upstream from the tape pressing unit 650 as a scissors-type unit having a movable cutter 250 which performs full-cut by sliding along a fixed cutter 210.

As illustrated in FIG. 5A, during printing on the tape-shaped material 160 by the tape printer 5, the pressing surface 651 of the tape pressing unit 650 and the guiding surface 611 of the tape guiding unit 610 are kept separated from each other. The tape-shaped material 160 moves (toward the left in FIG. 5A) through the clearance between the tape guiding unit 610 and the tape pressing unit 650 separated from each other along the guiding surface 611 with the progress of the printing. At the time of full-cut after printing, the tape pressing unit 650 starts moving toward the tape guiding unit 610 as illustrated in FIG. 5B, and the pressing surface 651 presses the tape-shaped material 160 against the guiding surface 611. This step allows the tape-shaped material 160 to be sandwiched between the pressing surface 651 and the guiding surface 611 and fixed thereat. After the tape-shaped material 160 is fixed, the movable cutter 250 performs cutting for full-cut of the tape-shaped material 160.

According to the tape pressing mechanism 600 in the related art whose pressing surface 651 fixes the tape-shaped material 160 by pressing the guiding surface 611 with the tape-shaped material 160 sandwiched between the pressing surface 651 and the guiding surface 611, however, the tape-shaped material 160 still has a loose portion between a tape cartridge 15 and the pressing surface 651 in some cases as illustrated in FIG. 5B. Thus, when the tape-shaped material 160 is cut by the full-cut unit 200, for example, the cutting position is difficult to be stabilized. In this case, there is a possibility that distortion is produced on the cut surface of the tape-shaped material 160 after cutting.

Thus, such a cutting device which has a tape pressing mechanism capable of removing looseness of a tape-shaped material, and such a tape printer which includes the cutting device of this type have been demanded.

### SUMMARY

An advantage of some aspects of the invention is to provide a technology for solving at least a part of the problems described above and the invention can be embodied as the following forms or application examples.

### APPLICATION EXAMPLE 1

This application example of the invention is directed to a cutting device which cuts a tape-shaped material in a width direction of the tape-shaped material and includes a tape pressing mechanism which presses the tape-shaped material at the time of cutting the tape-shaped material. The tape pressing mechanism includes a tape guiding unit which has a guiding surface for guiding the tape-shaped material and a receiving surface as a concaved portion with respect to the guiding surface, and a tape pressing unit which has a pressing surface for pressing the receiving surface of the tape guiding unit with the tape-shaped material sandwiched between the pressing surface and the receiving surface.

According to this cutting device, the tape-shaped material is pressed by the pressing surface of the tape pressing unit and fixed thereat in such a manner as to be inserted into the receiving surface as the concave portion of the tape guiding unit at the time of cutting the tape-shaped material. This insertion of the tape-shaped material into the receiving surface allows the amount of looseness (length of looseness) to be received (absorbed) by the receiving surface, and thus allows looseness of the tape-shaped material to be removed. Thus, the cutting device which incorporates the tape pressing mechanism capable of removing looseness of the tape-shaped material can be provided.

### APPLICATION EXAMPLE 2

In the cutting device according to the above application example, it is preferable that the receiving surface is formed in the width direction of the tape-shaped material.

According to this cutting device, the receiving surface is formed in the width direction of the tape-shaped material. In this structure, stable fixing of the position of the tape-shaped material in the width direction of the tape-shaped material at the time of cutting the tape-shaped material in the width direction can be achieved as well as removal of looseness of the tape-shaped material. Thus, when cutting the tape-shaped material, the cutting position can be stabilized. Accordingly, distortion on the cut surface after cutting can be reduced.

### APPLICATION EXAMPLE 3

In the cutting device of the above application example, it is preferable that the shape of the receiving surface is substantially uniform in the width direction of the tape-shaped material.

According to this cutting device, the shape of the receiving surface is substantially equalized in the width direction of the tape-shaped material. Thus, a pressing force applied to the fixed tape-shaped material becomes substantially uniform. Accordingly, fixing of the tape-shaped material can be further stabilized.

### APPLICATION EXAMPLE 4

In the cutting device of the above application example, it is preferable that at least either the pressing surface of the tape pressing unit or the receiving surface of the tape guiding unit is made of elastic material.

According to this cutting device, at least either the pressing surface or the receiving surface is made of elastic material. Thus, even when the tape pressing mechanism has assembly dimensional errors or the like, the tape pressing mechanism can absorb these errors and securely press and fix the tape-shaped material.

### APPLICATION EXAMPLE 5

In the cutting device of the above application example, it is preferable that the pressing surface has an outer peripheral surface curved in a convex shape.

According to this cutting device, the pressing surface having the outer peripheral surface curved in the convex shape as the portion initially contacting the tape-shaped material can make constant contact with the tape-shaped material. Thus, stable contact and stable pressing after contact can be achieved.

### APPLICATION EXAMPLE 6

This application example of the invention is directed to a tape printer including: the cutting device according to any one of the above application examples; and a print driving device which performs printing on the tape-shaped material by driving a tape cartridge containing the tape-shaped material.

This tape printer includes the cutting device providing the advantages described above. Thus, the tape printer capable of removing looseness of the tape-shaped material and reducing distortion on the cut surface when cutting the tape-shaped material can be provided.

### BRIEF DESCRIPTION OF THE DRAWINGS

The invention will be described with reference to the accompanying drawings, wherein like numbers reference like elements.

FIGS. 1A and 1B are perspective views of a tape printer according to a first embodiment.

FIGS. 2A and 2B are a plan view and a perspective view, respectively, schematically illustrating a main part of a cutting device.

FIGS. 3A and 3B are a plan view and a perspective view, respectively, schematically illustrating the main part of the cutting device.

FIGS. 4A and 4B are perspective views schematically illustrating a main part of a cutting device according to a second embodiment.

FIGS. 5A and 5B are plan views illustrating a main part of a cutting device included in a tape printer in related art.

### DESCRIPTION OF EXEMPLARY EMBODIMENTS

Exemplary embodiments according to the invention are hereinafter described with reference to the drawings.

### First Embodiment

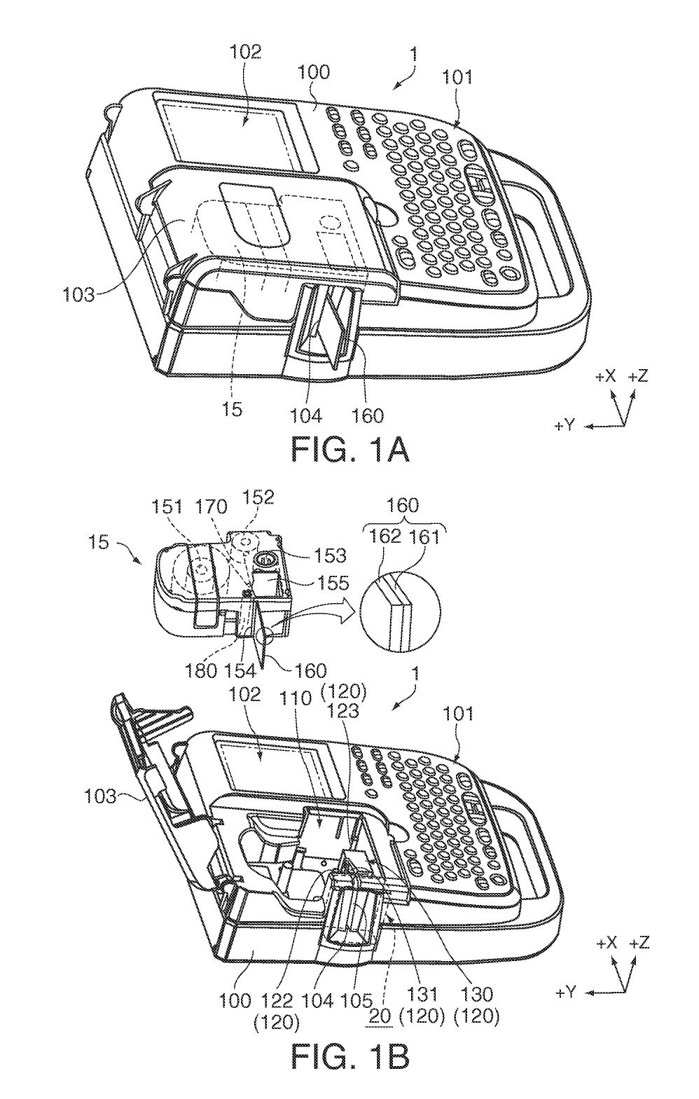

FIGS. 1A and 1B are perspective views of a tape printer according to a first embodiment. More specifically, FIG. 1A is a perspective view illustrating the tape printer whose open/close cover is closed, and FIG. 1B is a perspective view illustrating the tape printer whose open/close cover is opened. FIG. 1A shows a condition in which a tape cartridge 15 is attached to an attachment unit 110. FIG. 1B shows a condition in which the tape cartridge 15 is removed from the attachment unit 110. The external structure of a tape printer 1 is now described with reference to FIGS. 1A and 1B.

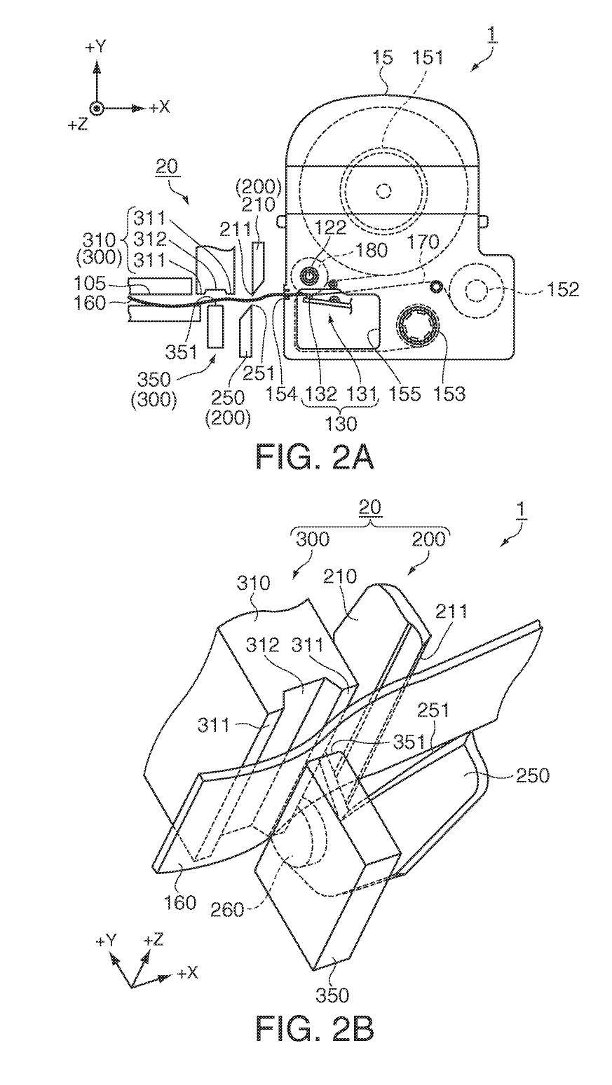

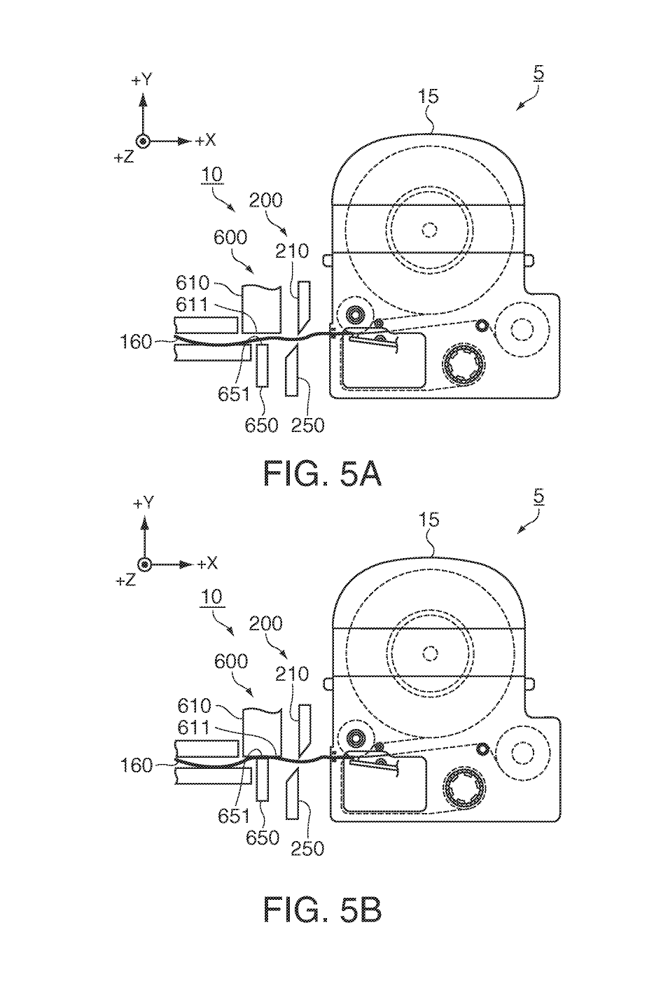

In FIGS. 1A and 1B, the direction from an operation panel 101 of the tape printer 1 to the tape cartridge 15 (from the right to the left in the figures) corresponds to a Y axis (+Y axis) direction, the direction from a tape ejection slot 104 to the tape cartridge 15 (from the lower side to the upper side in the figures) corresponds to an X axis (+X axis) direction, and the direction crossing the Y axis direction and the X axis direction at right angles corresponds to a Z axis direction (+Z axis direction extending from the back surface to the front surface). In FIGS. 2A through 5B, the respective components are shown by using the XYZ rectangular coordinate system defined in FIGS. 1A and 1B. The Z axis direction corresponds to the height direction, the thickness direction, and the up-down direction of the tape printer 1. In the following explanation, the respective directions are expressed by using the XYZ rectangular coordinate system as necessary.

The external housing of the tape printer 1 is constituted by an external case 100. The tape printer 1 includes the operation panel 101 disposed on the upper surface of the external case 100 on the −Y axis side and having various input keys. The tape printer 1 also includes a display 102 on the upper surface of the external case 100 on the +Y axis side. The tape printer 1 further includes an open/close cover 103 freely openable and closable disposed adjacent to the display 102. Though not shown in the figures, the external case 100 contains a power source device, various types of display lamps, a trimmer device and other components. The external case 100 further accommodates a circuit board on which a controller for supervising and controlling the operation of the tape printer 1 is mounted, and other units.

As illustrated in FIG. 1B, the attachment unit 110 is provided below the open/close cover 103 (−Z axis side) to accommodate the tape cartridge 15 such that the tape cartridge 15 can be freely attachable to and detachable from the attachment unit 110. A platen roller rotation shaft 122, an ink ribbon winding shaft 123, a printing head unit 130 and others are extended to reach the inside of the attachment unit 110. For attachment and detachment of the tape cartridge 15, the open/close cover 103 is opened. After the tape cartridge 15 is attached or detached, the open/close cover 103 is closed.

As illustrated in FIG. 1B, a cutting device 20 which performs full-cut and half-cut of the tape-shaped material 160 is disposed inside the external case 100 at a position downstream from the attachment unit 110 in the tape feeding direction (−X axis side). Furthermore, the tape ejection slot 104 through which the tape-shaped material 160 separated by full-cut is discharged to the outside of the device is formed on the side surface of the external case 100 at a position downstream from the cutting device 20 in the tape feeding direction.

A print driving device 120 containing the platen roller rotation shaft 122, the ink ribbon winding shaft 123, the printing head unit 130 and others is disposed on the lower side (−Z axis side) of the attachment unit 110. Printing on the tape-shaped material 160 accommodated in the tape cartridge 15 can be performed by actuating the print driving device 120.

The cutting device 20 according to this embodiment is disposed on the left side (−X axis side) of the attachment unit 110. The cutting device 20 performs half-cut and full-cut, and discharges the tape-shaped material 160 after full-cut to the outside through the tape ejection slot 104.

FIGS. 2A and 2B are a plan view and a perspective view, respectively, schematically illustrating a main part of the cutting device. More specifically, FIG. 2A is a plan view schematically showing the main part of the cutting device and the tape cartridge, and FIG. 2B is a perspective view schematically showing the main part of the cutting device. FIGS. 2A and 2B illustrate the condition of the cutting device 20 during printing of the tape printer 1, showing the full-cut unit 200 and the tape pressing mechanism 300 as the main part of the cutting device 20. The sizes of the respective components shown in the figures are varied as necessary for convenience of the explanation. The structure of the tape cartridge, and the structure and operation of the print driving device 120 are initially explained with reference to FIGS. 1A and 1B and FIG. 2A.

The tape cartridge 15 accommodates a tape supply spool 151 to which the tape-shaped material 160 wound in a roll shape is attached as illustrated in FIGS. 1B and 2A. These figures show the condition in which the end of the tape-shaped material 160 wound around the tape supply spool 151 is drawn out through a tape supply port 154 formed on a side wall of the tape cartridge 15 on the cutting device 20 side. As illustrated in FIG. 1B, the tape-shaped material 160 is constituted by a lamination of an adhesive-coated printing tape 161 which becomes a printed material, and a released paper 162.

A platen roller 180 rotatable with the platen roller rotation shaft 122 by engagement therewith is provided in the vicinity of the tape supply port 154, and an opening 155 is formed on the side opposite to the platen roller 180. A printing head 131 faces to the opening 155 with the tape-shaped material 160 sandwiched between the printing head 131 and the platen roller 180. A ribbon supply spool 152 and a ribbon winding spool 153 are disposed in the vicinity of the opening 155. The ribbon supply spool 152 supplies an ink ribbon 170 to the space between the platen roller 180 and the printing head 131 (a head main body 132). The ribbon winding spool 153 rotates with the ink ribbon winding shaft 123 by engagement therewith such that the ink ribbon 170 can be wound around the ribbon winding spool 153.

The platen roller rotation shaft 122 and the ink ribbon winding shaft 123 of the print driving device 120 stand on a frame (not shown) in such a manner as to be rotatable. In this arrangement, a rotational force of a driving motor (not shown) can be simultaneously transmitted to the platen roller rotation shaft 122 and the ink ribbon winding shaft 123 via a train of gears (not shown). These components are hidden below the attachment unit 110 as illustrated in FIG. 1B, and only the platen roller rotation shaft 122, the ink ribbon winding shaft 123, and the printing head unit 130 are extended to the inside of the attachment unit 110.

The printing head 131 (see FIG. 2A) of the printing head unit 130 on which the head main body 132 having a thermal head and the like is mounted is supported by a head holder (not shown) at a position opposed to the platen roller rotation shaft 122. The head holder is rotatable around a head holder shaft (not shown).

When the tape cartridge 15 is attached to the attachment unit 110 (condition shown in FIG. 1A), engagements between the platen roller rotation shaft 122 and the platen roller 180 and between the ink ribbon winding shaft 123 and the ribbon winding spool 153 are both achieved. When the open/close cover 103 is closed, the printing head 131 (head main body 132) of the printing head unit 130 facing to the inside of the opening 155 of the tape cartridge 15 presses the platen roller 180 with the ink ribbon 170 and the tape-shaped material 160 sandwiched between the printing head 131 and the platen roller 180.

When a printing request is issued from the controller, the driving motor starts operation in response to the request and initiates rotations of the platen roller 180 and the ribbon winding spool 153. As a result, the tape-shaped material 160 is supplied, and ink on the ink ribbon 170 is transferred to the printing tape 161 by thermal transfer by the function of the printing head 131 (head main body 132) to perform printing. The tape-shaped material 160 after printing is sequentially fed from the tape supply port 154 toward the tape ejection slot 104. The ink ribbon after printing is sequentially wound around the ribbon winding spool 153.

The tape-shaped material 160 supplied from the tape supply port 154 of the tape cartridge 15 after printing enters the inside of the cutting device 20. As illustrated in FIGS. 2A and 2B, the tape-shaped material 160 having entered the inside of the cutting device 20 passes through the clearances between the fixed cutter 210 and the movable cutter 250 of the full-cut unit 200 and between a tape guiding unit 310 and a tape pressing unit 350 of the tape pressing mechanism 300 to be fed toward the tape ejection slot 104. These clearances are covered by a tape discharge path 105 concaved on the external case 100 and communicating with the space between the attachment unit 110 and the tape ejection slot 104 of the tape printer 1 (see FIG. 1B), and thus are not visually recognized in appearance.

For attachment of the tape cartridge 15 to the attachment unit 110, the tape-shaped material 160 extended from the tape supply port 154 is inserted into the tape discharge path 105 from above (+Z axis direction). By insertion of the tape-shaped material 160 into the tape discharge path 105, the tape-shaped material 160 is attached to the respective clearances formed by the full-cut unit 200 and the tape pressing mechanism 300.

The structure and operation of the cutting device 20 are now explained.

The cutting device 20 includes the full-cut unit 200, a half-cut unit (not shown), the tape pressing mechanism 300, and a tape discharge mechanism (not shown). The half-cut unit (not shown), the full-cut unit 200, the tape pressing mechanism 300, and the tape discharge mechanism (not shown) are disposed in this order on the downstream side of the tape cartridge 15. For convenience of the explanation, the full-cut device 200 and the tape pressing mechanism 300 as the main part of the cutting device 20 in this embodiment are chiefly shown in the figures. The respective sizes shown in the figures are varied as necessary.

The full-cut unit 200 has the fixed cutter 210 and the movable cutter 250 supported by the fixed cutter 210 via a support shaft 260 in such a manner as to be freely rotatable, and performs full-cut as a scissors-type cutting unit. During printing of the tape printer 1, the movable cutter 250 is moved around the support shaft 260 to be disposed away from the fixed cutter 210. The tape-shaped material 160 after printing is fed through the clearance between a cutter edge 211 of the fixed cutter 210 and a cutter edge 251 of the movable cutter 250 toward the tape ejection slot 104.

The half-cut unit (not shown) has a structure substantially similar to that of the full-cut unit 200 except for the point that the half-cut unit has a cut limit portion disposed on the fixed cutter for limiting the cutting amount of the movable cutter and performs half-cut as a press-cut type cutter. In this structure, the printing tape 161 of the tape-shaped material 160 after half-cut is cut away, but the released paper 162 is not cut. Thus, the respective pieces of the tape-shaped material 160 are connected with each other by the released paper and fed to the tape ejection slot.

The tape pressing mechanism 300 is disposed at a position downstream from the full-cut unit 200 as a mechanism for pressing and fixing the tape-shaped material 160 at the time of cutting (half-cut or full-cut) of the tape-shaped material 160. The tape pressing mechanism 300 has the tape guiding unit 310 and the tape pressing unit 350.

The tape guiding unit 310 has a guiding surface 311 for guiding the tape-shaped material 160, and a receiving surface 312 as a concave portion with respect to the guiding surface 311. The guiding surface 311 is a surface extending substantially in parallel with the X-Z plane. As described above, the guiding surface 311 is located substantially on the same plane as the concave surface of the tape discharge path 105. Thus, the tape-shaped material 160 is guided by (along) the guiding surface 311 and fed to the tape ejection slot 104.

The receiving surface 312 extends in the direction along the width of the tape-shaped material 160 (Z axis direction). In this embodiment, the receiving surface 312 is formed in a direction (Z axis direction) substantially perpendicular to the longitudinal direction of the tape-shaped material 160 (X axis direction). In other words, the receiving surface 312 is formed substantially in parallel with the cutting direction for cutting the tape-shaped material 160 by using the full-cut unit 200.

The receiving surface 312 has a substantially rectangular concave shape which is substantially uniform in the width direction (Z axis direction) on the X-Y plane, and is constituted by a flat surface. Thus, the depth of the receiving surface 312 from the guiding surface 311 is substantially uniform in the width direction (Z axis direction). The receiving surface 312 extends from the upper end to the lower end of the guiding surface 311 so as to deal with tape widths of various types of the tape-shaped material 160 contained in the tape cartridge 15 attachable to the tape printer 1.

The tape pressing unit 350 has a pressing surface 351. The pressing surface 351 presses the receiving surface 312 of the tape guiding unit 310 with the tape-shaped material 160 sandwiched between the pressing surface 351 and the receiving surface 312 at the time of cutting the tape-shaped material 160. The pressing surface 351 is equipped on the side opposed to the receiving surface 312 such that the tape-shaped material 160 can be sandwiched between the pressing surface 351 and the receiving surface 312. The surface of the pressing surface 351 (outer peripheral surface) on the side opposed to the receiving surface 312 is a flat surface shaped in correspondence with the concave shape of the receiving surface 312.

During printing of the tape printer 1, the tape pressing unit 350 (pressing surface 351) is disposed away from the tape guiding unit 310 (guiding surface 311). The tape-shaped material 160 after printing is guided by the tape guiding unit 310 (guiding surface 311) to be fed through the clearance between the tape pressing unit 350 and the tape guiding unit 310 toward the tape ejection slot 104.

During printing of the tape printer 1, the tape-shaped material 160 supplied from the tape supply port 154 of the tape cartridge 15 passes through the tape discharge path 105 with looseness produced by winding curls and looseness produced by running as illustrated in FIGS. 2A and 2B.

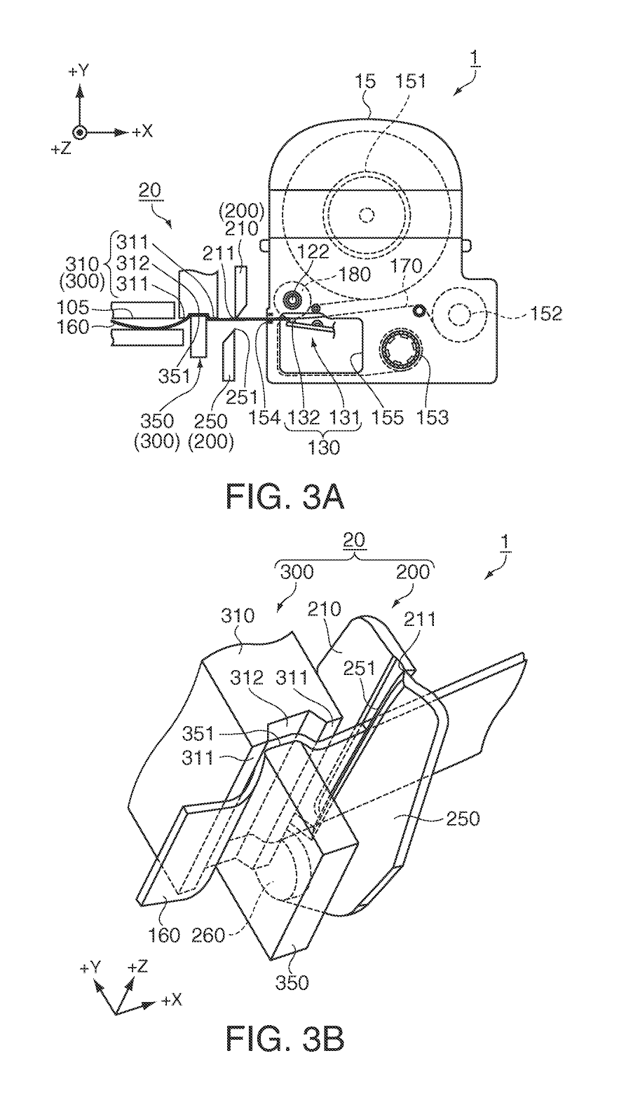

FIGS. 3A and 3B are a plan view and a perspective view, respectively, schematically illustrating a main part of the cutting device. More specifically, FIG. 3A is a plan view schematically showing the main part of the cutting device and the tape cartridge, and FIG. 3B is a perspective view schematically showing the main part of the cutting device. FIGS. 3A and 3B illustrate the condition of the cutting device 20 during cutting by the tape printer 1, showing the full-cut unit 200 and the tape pressing mechanism 300 as the main part of the cutting device 20 similarly to FIGS. 2A and 2B. The sizes of the respective components shown in the figures are varied as necessary for convenience of the explanation. The operation of the cutting device 20 during cutting is now explained with reference to FIGS. 3A and 3B.

For cutting the tape-shaped material 160 by using the cutting device 20, the tape pressing unit 350 starts moving toward the tape guiding unit 310 (receiving surface 312) before the cutting operation of the full-cut unit 200, and the pressing surface 351 of the tape pressing unit 350 comes into contact with the tape-shaped material 160. Then, the pressing surface 351 moves while pressing the tape-shaped material 160 to contact the tape-shaped material 160 with the concaved surface of the receiving surface 312 of the tape guiding unit 310 and press the tape-shaped material 160 against the concaved surface as illustrated in FIGS. 3A and 3B.

The tape-shaped material 160 after attached to the tape printer 1 in the closed condition of the open/close cover 103 is sandwiched between the platen roller 180 inside the tape cartridge 15 and the printing head 131 (head main body 132) to be fixed thereat. As described above, the tape-shaped material 160 enters the concaved surface of the receiving surface 312 at a position downstream from the full-cut unit 200 by the function of the tape pressing mechanism 300, where the tape-shaped material 160 is pressed by the pressing surface 351 and fixed thereat.

The contact between the tape-shaped material 160 and the concaved surface of the receiving surface 312 allows the amount of looseness (length of looseness) produced in the area from the platen roller 180 to the receiving surface 312 (or pressing surface 351) to be received (absorbed) by the receiving surface 312, and thus allows looseness of the tape-shaped material 160 to be removed. Thus, the tape-shaped material 160 is tensioned in the area between the platen roller 180 and the receiving surface 312 with looseness produced therein removed. This condition is maintained until the cutting operation by the full-cut unit 200 is finished.

Under the condition in which the pressing surface 351 presses the tape-shaped material 160 against the receiving surface 312 and fixes the tape-shaped material 160 thereto by the function of the tape pressing mechanism 300, the full-cut unit 200 starts cutting operation. The movable cutter 250 of the full-cut unit 200 rotates around the support shaft 260 toward the fixed cutter 210. By this operation, the cutter edge 251 of the movable cutter 250 comes into sliding along the cutter edge 211 of the fixed cutter 210 from the support shaft 260 side for performing full-cut. FIG. 3B shows a condition of the tape-shaped material 160 immediately after full-cut.

When the full-cut operation by the full-cut unit 200 is finished, the tape pressing unit 350 of the tape pressing mechanism 300 releases pressing against the tape guiding unit 310 and returns to the initial position (position of the tape pressing unit 350 in FIGS. 2A and 2B). The tape discharge mechanism (not shown) starts operation in accordance with the returning action of the tape pressing unit 350 to the initial position. The cut and separated tape-shaped material 160 is discharged through the tape ejection slot 104 to the outside by the operation of the tape discharge mechanism.

In case of the cutting operation by the half-cut unit (not shown), the tape pressing mechanism 300 executes operation similar to the full-cut operation described above. Thus, the half-cut operation is performed while removing looseness of the tape-shaped material 160.

According to this embodiment, the following advantages can be offered.

According to the cutting device 20 in this embodiment, the tape-shaped material 160 having reached the step of cutting is pressed by the pressing surface 351 of the tape pressing unit 350 and fixed thereat in such a manner as to be inserted into the concaved receiving surface 312 of the tape guiding unit 310. By insertion of the tape-shaped material 160 into the receiving surface 312, the amount of looseness (length of looseness) of the tape-shaped material 160 can be received (absorbed) by the receiving surface 312. Thus, looseness of the tape-shaped material 160 can be removed.

According to the cutting device 20 in this embodiment, the receiving surface 312 is formed in the width direction of the tape-shaped material 160. In this structure, stable fixing of the position of the tape-shaped material 160 in the width direction of the tape-shaped material 160 at the time of cutting the tape-shaped material 160 in the width direction can be achieved as well as removal of looseness of the tape-shaped material 160. Thus, when cutting the tape-shaped material 160, the cutting position can be stabilized. Accordingly, distortion on the cut surface after cutting can be reduced.

According to the cutting device 20 in this embodiment, the shape of the receiving surface 312 on the X-Y plane is substantially equalized in the width direction of the tape-shaped material 160. Thus, a pressing force applied to the fixed tape-shaped material 160 becomes substantially uniform. Accordingly, fixing of the tape-shaped material 160 can be further stabilized. Moreover, the structures of the receiving surface 312 and the pressing surface 351 can be simplified.

According to the tape printer 1 in this embodiment which includes the cutting device 20 capable of providing the above advantages, looseness of the tape-shaped material 160 can be removed when cutting the tape-shaped material 160. Thus, the tape printer 1 becomes a device which can improve cutting quality by reducing distortion on the cut surface.

### Second Embodiment

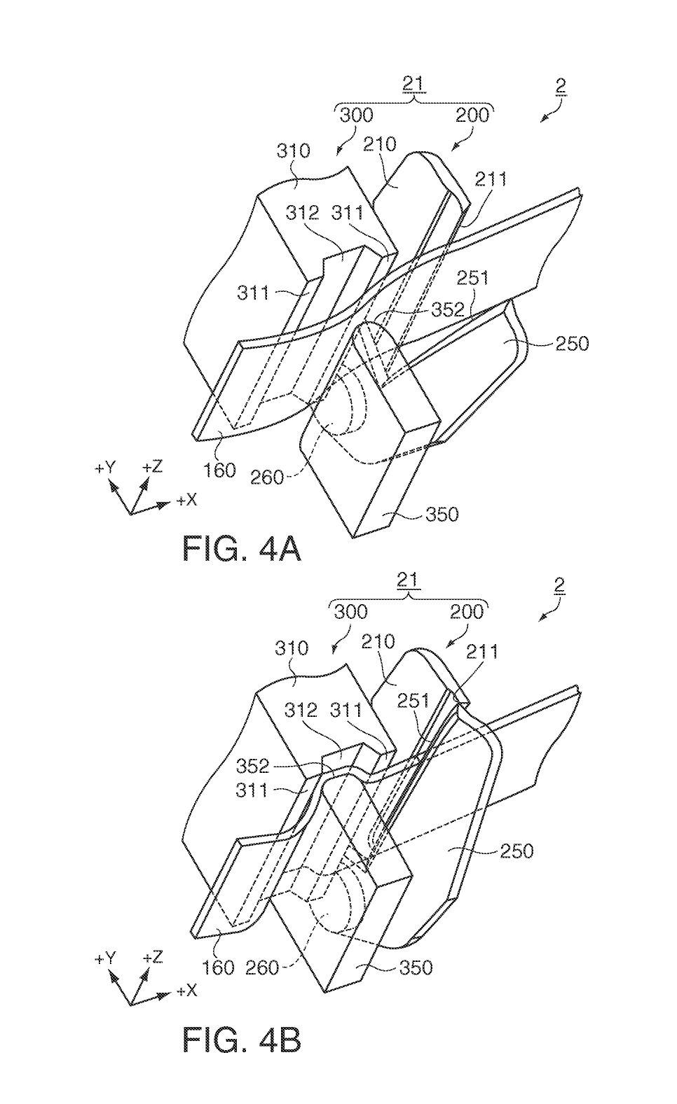

FIGS. 4A and 4B are perspective views schematically illustrating a main part of a cutting device included in a tape printer according to a second embodiment. More specifically, FIG. 4A is a perspective view schematically showing a condition of the cutting device during printing by the tape printer, and FIG. 4B is a perspective view schematically showing a condition of the cutting device during cutting by the tape printer. FIGS. 4A and 4B illustrate the full-cut unit 200 and the tape pressing mechanism 300 as the main part of a cutting device 21 included in a tape printer 2. The sizes of the respective components shown in the figures are varied as necessary for convenience of the explanation.

The cutting device 21 included in the tape printer 2 according to this embodiment is different from the cutting device 20 in the first embodiment in the structure of the tape pressing unit 350 of the tape pressing mechanism 300. More specifically, the tape pressing unit 350 in the second embodiment has a pressing surface 352 different from the pressing surface 351. In other points, the cutting device 21 has structures similar to those of the cutting device 20 in the first embodiment, and performs similar operations. Similar reference numbers are given to similar parts, and only operations different from those in the first embodiment are herein described.

The structure and operation of the pressing surface 352 of the tape pressing unit 350 are now explained with reference to FIGS. 4A and 4B. As illustrated in FIG. 4A, the surface of the pressing surface 352 (outer peripheral surface) in this embodiment on the side opposed to the receiving surface 312 has a curved cross section in a convex shape. The pressing surface 352 is made of elastic material (rubber material in this embodiment).

As illustrated in FIG. 4B, at the time of cutting the tape-shaped material 160 by using the cutting device 21, the tape pressing unit 350 operates similarly to the first embodiment prior to the cutting operation of the full-cut unit 200. As a result, the pressing surface 352 contacts the tape-shaped material 160 with the concaved portion of the receiving surface 312 of the tape guiding unit 310 and presses the tape-shaped material 160 against the concaved portion. In this case, the pressing surface 352 presses the tape-shaped material 160 against the receiving surface 312 along the concaved portion of the receiving surface 312 by using elasticity to fix the tape-shaped material 160 to the receiving surface 312.

The contact between the tape-shaped material 160 and the concaved portion of the receiving surface 312 allows the amount of looseness (length of looseness) produced in the area from the platen roller 180 to the receiving surface 312 (or pressing surface 352) to be received (absorbed) by the receiving surface 312, and thus allows looseness of the tape-shaped material 160 to be removed. Thus, the tape-shaped material 160 is tensioned in the area between the platen roller 180 and the receiving surface 312 with looseness produced therein removed. This condition is maintained until the cutting operation by the full-cut unit 200 is finished. The operations of the cutting device 21 to be performed after this step are similar to those of the cutting device 20 in the first embodiment.

According to the cutting device 21 in this embodiment, the following advantages can be offered as well as those of the cutting device 20 in the first embodiment.

According to the cutting device 21 in this embodiment, the pressing surface 352 is made of elastic material. Thus, even when the tape pressing mechanism 300 has assembly dimensional errors or the like, the tape pressing mechanism 300 can absorb these errors and securely press the tape-shaped material 160 to fix the tape-shaped material 160 to the receiving surface 312. Moreover, the tape pressing mechanism 300 presses the tape-shaped material 160 along the receiving surface 312 to fix the tape-shaped material 160 thereto by using the elasticity of the pressing surface 352. Thus, the pressing force applied to the fixed tape-shaped material 160 becomes more uniform.

According to the cutting device 21 in this embodiment, the pressing surface 352 having the outer peripheral surface curved in the convex shape as the portion initially contacting the tape-shaped material 160 can make more constant contact with the tape-shaped material 160 than that of a flat surface or the like. Thus, pressing becomes more stable.

The invention is not limited to the first and second embodiments described herein but may be practiced otherwise without departing from the scope of the invention. As such, various changes, improvements and the like including the following modified examples may be made.

According to the first and second embodiments, the receiving surface 312 is formed in the direction (Z axis direction) substantially perpendicular to the longitudinal direction (X axis direction) of the tape-shaped material 160. However, the receiving surface 312 may be disposed in other directions as long as the receiving surface 312 extends along the width of the tape-shaped material (Z axis direction). Thus, the receiving surface 312 may be slightly inclined to the direction (Z axis direction) perpendicular to the longitudinal direction (X axis direction) of the tape-shaped material 160.

According to the first and second embodiments, the shape of the receiving surface 312 on the X-Y plane is constituted by a substantially rectangular flat surface which is substantially uniform in the width direction (Z axis direction). However, the receiving surface 312 may have other shapes as long as the shape on the X-Y plane is concave and substantially uniform in the width direction (Z axis direction). Thus, the receiving surface 312 may have a curved surface which is substantially uniform in the width direction (Z axis direction).

The receiving surface 312 is not required to be formed from the upper end to the lower end of the guiding surface 311 as in the first and second embodiments but may have a length in the width direction only sufficient for receiving the length of the tape-shaped material 160 in the width direction, and only sufficient for receiving the length of the pressing surface 351 in the width direction.

According to the second embodiment, the pressing surface 352 is made of elastic material. However, only the receiving surface 312 may be made of elastic material, or both the pressing surface 352 and the receiving surface 312 may be made of elastic material. In these examples, even when the tape pressing mechanism 300 has assembly dimensional errors or the like, the tape pressing mechanism 300 can absorb these errors and securely press the tape-shaped material 160 to fix the tape-shaped material 160 to the receiving surface 312.

What is claimed is:

1. A cutting device which cuts a tape-shaped material in a width direction of the tape-shaped material, comprising:
a tape pressing mechanism which presses the tape-shaped material at the time of cutting the tape-shaped material,
the tape pressing mechanism comprising,
a tape guiding unit which has a guiding surface for guiding the tape-shaped material and a receiving surface as a concaved portion with respect to the guiding surface, and
a tape pressing unit which has a pressing surface for pressing the receiving surface of the tape guiding unit with the tape-shaped material sandwiched between the pressing surface and the receiving surface.

2. The cutting device according to claim 1, wherein the receiving surface is formed in the width direction of the tape-shaped material.

3. The cutting device according to claim 2, wherein the shape of the receiving surface is substantially uniform in the width direction of the tape-shaped material.

4. The cutting device according to claim 1, wherein at least either the pressing surface of the tape pressing unit or the receiving surface of the tape guiding unit is made of elastic material.

5. The cutting device according to claim 1, wherein the pressing surface has an outer peripheral surface curved in a convex shape.

6. A tape printer comprising:
the cutting device according to claim 1; and
a print driving device which performs printing on the tape-shaped material by driving a tape cartridge containing the tape-shaped material.
